(19) United States
(12) Patent Application Publication
(10) Pub. No.: US 2002/0077415 A1
(43) Pub. Date: Jun. 20, 2002

(54) Creative latex for non-hazardous use in shoe-making

(76) Inventors: Ching-Long Chen, Taipei City (TW); Shi-Hou Chen, Taipei City (TW); Szu-Wei Chen, Taipei City (TW)

Correspondence Address: BACON & THOMAS, Fourth Floor, 625 Slaters Lane, Alexandria, VA, 22314-1176, US

(21) Appl. No.: 09/737,479

(22) Filed: Dec. 18, 2000

(51) Int. Cl. B32B 5/02; C08K 3/00

(52) U.S. Cl. 524/845; 442/97

(57) ABSTRACT

The invention provides a creative latex based mainly vinyl acetate and one of methyl methacrylate, ethyl methacrylate or methyl acrylate, for non-hazardous use in shoe-making. A rigid liner can be made from said latex by any conventional technique wherein a base cloth such as a non-woven fabric is impregnated with said latex, and then the liner can be cut into shoe counter, toe and respective parts of shoe in any appropriate shape, characterized in that wherein said cut and shaped rigid liner is softened with alcohol and thereby produce adhesion, and then, the liner is inserted between the vamp and lining of the toe puff, counter and respective part of a shoe, bonds intimately and sets into fixed shape. Usage of the latex according to the invention in the shoe-making process can avoid serious hazard caused by the conventional latex that must use toluene as the solvent for softening.

### BACKGROUND OF THE INVENTION

1. Field of the Invention

The invention relates to a latex for impregnating base cloth and forming rigid lining material therefrom, which rigid lining material can be made softened to produce adhesion by reacting with a specific solvent during a subsequent process of shoe-making, and after being inserted into a corresponding part of a shoe, it can be cured to render said part of the shoe set and stiffened.

2. Description of the Prior Art

Currently, a rigid shoe liner commonly used in the shoe-making industry is made by impregnating a base cloth with polystyrene latex, drying and roll pressing into a rigid liner which, after being cut into a desired shape, is softened with a solvent and meanwhile yields adhesion, then bonds to a corresponding part of a shoe to be cured and set. Since polystyrene latex is made essentially from mixing and reacting styrene with acrylic acid in the presence of sodium dodecyl benzene sulfonate, aqueous ammonia solution, water and the like under heating, a rigid liner fabricated from thus-produced latex with a base cloth must be softened with a toxic solvent such as toluene to produce adhesion for using in the shoe-making process. The use of such toxic solvent might be harmful for the worker around the working place and pollutes the environment. The usage has been prohibited by developed countries. An expensive hot-melt adhesive has to be used for fabricating rigid shoe liner before finding a new latex rigid liner that can be softened with a non-hazardous solvent. Although a hot-melt adhesive can be softened without any solvent, special equipment for hot melting and set is necessary and hence increases several folds of the investment cost

In view of the foregoing, the prior art product still has an advantage and is not a perfect design.

As an aim to embody the above advantages and to provide an improvement, the inventor has been studied intensively and persistently for many years, and as a result, found successfully the novel latex for non-hazardous use in the shoe-making.

### SUMMARY OF THE INVENTION

The invention provides therefore a novel latex comprising as main components of vinyl acetate and one of methyl methacrylate, ethyl methacrylate and methyl acrylate, preferably, vinyl acetate and methyl methacrylate, and a rigid liner made from said latex with a base cloth, characterized in that said rigid liner can be softened with a non-hazardous solvent, bonding and cured for purpose of shaping and stiffening.

### DETAILED DESCRIPTION OF THE PREFERRED EMBODIMENT

The latex according to the invention comprises as main components vinyl acetate and one of methyl methacrylate, ethyl methacrylate and methyl acrylate, and additives conventionally used in the production of a latex; wherein vinyl acetate comprises 50-72% by weight of the main components of the latex; and wherein said additives comprise sodium dodecyl benzene sulfonate, alkyl epoxide ether, acrylic acid, ammonium persulfate, ammonia water and water. The latex can be prepared according to the following procedure:

a. compounding the above-mentioned main components with said additives in conventional dosage, adding about half amount of each of sodium dodecyl benzene sulfonate and alkyl epoxide ether and about 1/10 amount of water in a emulsion polymerization reactor and stirring for 10 minutes, then adding vinyl acetate and one of methyl methacrylate, ethyl methacrylate or methyl acrylate and acrylic acid to the resulting solution, and stirring homogeneously;

b. charging remaining sodium dodecyl benzene sulfonate and alkyl epoxide ether and about 8/10 amount of water in the reactor;

c. charging dropwise ammonium persulfate and remaining about 1/10 amount of water into a dropping tank;

d. heating the reactor to a temperature of 60° C., adding dropwise the above solution obtained in steps a and c into the reactor over a period of 3.5˜4 hours, and the temperature in the reactor is raised up to 80˜85° C.;

e. finally, after keeping the reactor at this temperature for 1 hour, evacuating and cooling to a temperature below 45° C., then adjusting pH of the content of the reactor to neutral with ammonia water to obtain a latex having a solid content of 34˜38%.

In another aspect of the invention, a rigid liner is fabricated from the thus-obtained latex and a base cloth by any conventional technique, and then the liner can be cut into shoe counter, toe and respective parts of a shoe in any appropriate shape, characterized in that wherein said cut and shaped rigid liner is softened with alcohol and thereby yields adhesion, and then, the liner is inserted between the vamp and lining of the toe puff, counter and respective part of a shoe, bonds intimately and sets into fixed shape. The procedure used for fabricating the rigid liner according to the invention can be carried out as follows. providing a base cloth (non-woven or fabrics)→latex impregnation→drying in a dryer at 140˜160° C. for about 5 minutes hot rolling flat under about 180° C.→cooling by a cooling roll→cutting into liners of standard size. This procedure is essentially a conventional process except that the latex used is the latex according to the invention.

The invention will be illustrated in more detail by way of the following non-limiting examples.

### EXAMPLE 1

65 kg of methyl methacrylate, 295 kg of vinyl acetate, 3.5 kg of sodium dodecyl benzene sulfonate, 8 kg of alkyl epoxide ether, 5 kg of acrylic acid, 3 kg of ammonium persulfate, 8 kg of ammonia water and 650 kg of water were provided. 2 kg of sodium dodecyl benzene sulfonate, 4 kg of alkyl epoxide ether, and 50 kg of water were added in an emulsion reactor and stirred for about 10 minutes. 295 kg of vinyl acetate, 65 kg of methyl methacrylate, and 5 kg of acrylic acid were added successively and stirred for emulsification. 1.5 kg of sodium dodecyl benzene sulfonate, 4 kg of alkyl epoxide ether and 550 kg of water were added in the reactor, and then added dropwise solution of 3 kg ammonium persulfate dissolved in 50 kg of water. The reactor was heated to a temperature of 60° C. The above prepared materials in the emulsion reactor and the addition tank were then added dropwise into the reactor over 3.5 hours, wherein the temperature in the reactor was raised to 80˜85° C. after keeping at this temperature for 1 hour, the reactor was evacuated and cooled to a temperature below 45° C. the content of the reactor was adjusted to a neutral pH with ammonia water. The latex thus-produced has a solid content of 34˜38%.

### EXAMPLE 2

90 kg of methyl methacrylate, 270 kg of vinyl acetate, 3.5 kg of sodium dodecyl benzene sulfonate, 7.5 kg of alkyl epoxide ether, 4 kg of acrylic acid, 2.5 kg of ammonium persulfate, 5 kg of ammonia water and 650 kg of water were provided. 2 kg of sodium dodecyl benzene sulfonate, 3.5 kg of alkyl epoxide ether, and 50 kg of water were added in an emulsion reactor and stirred for about 10 minutes. Two main components and acrylic acid were added successively and stirred for emulsification. 1.5 kg of sodium dodecyl benzene sulfonate, 4 kg of alkyl epoxide ether and 550 kg of water were added in the reactor, and then added dropwise solution ammonium persulfate dissolved in remaining amount of water. The subsequent procedure was carried out as in Example 1.

### EXAMPLE 3

180 kg of methyl methacrylate, 180 kg of vinyl acetate, 4 kg of sodium dodecyl benzene sulfonate, 8.5 kg of alkyl epoxide ether, 6 kg of acrylic acid, 2 kg of ammonium persulfate, 10 kg of ammonia water and 650 kg of water were provided. 2 kg of sodium dodecyl benzene sulfonate, 4 kg of alkyl epoxide ether, and 50 kg of water were added in an emulsion reactor and stirred for about 10 minutes. Two main components and acrylic acid were added successively and stirred homogeneously for emulsification. 2 kg of sodium dodecyl benzene sulfonate, 4.5 kg of alkyl epoxide ether and 550 kg of water were added in the reactor, and then added dropwise solution ammonium persulfate dissolved in remaining amount of water. The subsequent procedure was carried out as in Example 1 and 2.

The latex for non-hazardous use in shoe-making provided according to the invention has following advantages over the prior art technique:

1. Accessory additives and dosages thereof used in the preparation of the latex according to the invention differ not much to those in the conventional latex, and can be adjusted within a conventional range to meet various requirements of different types of shoes.

2. In the course of shoe-making, the latex and the rigid liner made therefrom can be softened with alcohol in addition to be softened with toluene, pollution from the hazardous solvent can thus be eliminated in the shoe-making and the cost of production can be lower not only than that of using hot-melt adhesive, but also than that of latex rigid liner using toluene as the solvent.

3. The latex according to the invention is applicable to the field other than shoe-making.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A latex for non-hazardous use in shoe-making, wherein said latex can be prepared according to the following procedure:
a. compounding main components having a composition of:
methyl methacrylate, ethyl methacrylate or methyl acrylate: 17-46 wt. %
vinyl acetate: 46-76 wt. %
with additives in conventional dosage as follows:
sodium dodecyl benzene sulfonate: 0.9-1 wt. %
alkyl epoxide ether: 2-2.2 wt. %
acrylic acid: 1.2-1.6 wt. %
ammonium persulfate: 0.5-0.8 wt. %
ammonia water: 1.5-2.6 wt. %
by adding about half amount of each of sodium dodecyl benzene sulfonate and alkyl epoxide ether and about 1/10 amount of water in an emulsion polymerization reactor and stirring for 10 minutes, then adding vinyl acetate and one of methyl methacrylate, ethyl methacrylate or methyl acrylate and acrylic acid to the resulting solution, and stirring homogeneously;
b. charging remaining sodium dodecyl benzene sulfonate and alkyl epoxide ether and about 8/10 amount of water in the reactor;
c. charging dropwise ammonium persulfate and remaining about 1/10 amount of water into a dropping tank;
d. heating the reactor to a temperature of 60° C., adding dropwise the above solution obtained in steps a and c into the reactor over a period of 3.5˜4 hours, and the temperature in the reactor is raised up to 80˜85° C.;
e. after keeping the reactor at this temperature for 1 hour, evacuating and cooling to a temperature below 45° C., then adjusting pH of the content of the reactor to neutral with ammonia water to obtain a latex having a solid content of 34˜38%.

2. A latex for non-hazardous use in shoe-making as recited in claim 1, wherein said main components is one of methyl methacrylate, ethyl methacrylate and methyl acrylate.

3. A latex for non-hazardous use in shoe-making as recited in claim 1, wherein vinyl acetate comprises 50-72% by weight of the two main components in said latex.

4. A rigid liner, which is fabricated by impregnating a base cloth with the latex for non-hazardous use in shoe-making as recited in claim 1, by any conventional technique, and then the liner can be cut into shoe counter, toe and respective parts of a shoe in any appropriate shape, characterized in that wherein said cut and shaped rigid liner is softened with alcohol and thereby produce adhesion, and then, the liner is inserted between the vamp and lining of the toe puff, counter and respective part of a shoe, bonds intimately and sets into fixed shape.
